(19) United States
(12) Patent Application Publication
(10) Pub. No.: US 2009/0142548 A1
(43) Pub. Date: Jun. 4, 2009

(54) AIR COOLED GAS TURBINE COMPONENTS AND METHODS OF MANUFACTURING AND REPAIRING THE SAME

(76) Inventors: David Bruce Patterson, Mason, OH (US); John Starkweather, Cincinnati, OH (US); Thomas Holland, Dayton, OH (US); Thomas Tomlinson, West Chester, OH (US)

Correspondence Address: GENERAL ELECTRIC COMPANY, GE AVIATION, ONE NEUMANN WAY MD H17, CINCINNATI, OH, 45215, US

(21) Appl. No.: 11/926,986

(22) Filed: Oct. 29, 2007

Related U.S. Application Data
(60) Provisional application No. 60/981,066, filed on Oct. 18, 2007.

(51) Int. Cl. B32B 3/10; B05D 3/12; B32B 43/00

(52) U.S. Cl. 428/137; 427/331; 427/355; 427/140

(57) ABSTRACT

A component suitable for use in a gas turbine engine. The component includes a substrate defining a surface of the component and has a first surface and a second surface. At least one aperture extends through the substrate from the first surface to the second surface, and has a first open area. The component has a first coating on at least one of the first surface and the second surface adjacent to the at least one aperture. The component also has a second coating overlying the first coating adjacent to the at least one aperture, such that at least a portion of the first coating is exposed adjacent to the at least one aperture. The first coating defines a second open area which is smaller than the first open area. In another aspect, a method of manufacturing a component suitable for use in a gas turbine engine, comprising the steps of forming the component from a substrate having a first surface and a second surface, forming at least one aperture through the substrate from the first surface to the second surface having a first open area, applying a first coating to at least one of the first surface and the second surface adjacent to the at least one aperture, the aperture remaining at least partially unobstructed by the first coating, applying a second coating to the first coating adjacent to the at least one aperture, the aperture remaining at least partially unobstructed by the second coating, and removing the second coating from the aperture, leaving most or all of the first coating to define a second open area which is smaller than the first open area. In a further aspect, a method of repairing a component suitable for use in a gas turbine engine, the method comprising the steps of removing coatings from the component, repairing any defects in the substrate of the component, and applying coatings as described herein.

### CROSS-REFERENCE TO RELATED APPLICATION

This application claims priority to U.S. Provisional Application Ser. No. 60/981,066, filed Oct. 18, 2007.

### BACKGROUND OF THE INVENTION

The technology described herein relates generally to gas turbine engines, and more particularly, to air-cooled components for use in gas turbines and methods of manufacturing and repairing such components.

A gas turbine engine includes a compressor for compressing air which is mixed with a fuel and channeled to a combustor wherein the mixture is ignited within a combustion chamber for generating hot combustion gases. At least some known combustors include a dome assembly, a cowling, and liners to channel the combustion gases to a turbine, which extracts energy from the combustion gases for powering the compressor, as well as producing useful work to propel an aircraft in flight or to power a load, such as an electrical generator. The liners are coupled to the dome assembly with the cowling, and extend downstream from the cowling to define the combustion chamber.

The operating environment within a gas turbine engine is both thermally and chemically hostile. Significant advances in high temperature alloys have been achieved through the formulation of iron, nickel and cobalt-base superalloys, though components formed from such alloys often cannot withstand long service exposures if located in certain sections of a gas turbine engine, such as the turbine, combustor or augmentor. A common solution is to protect the surfaces of such components with an environmental coating system, such as an aluminide coating or a thermal barrier coating (TBC) system. The latter typically includes an environmentally-resistant bond coat and a thermal barrier coating of ceramic deposited on the bond coat. Bond coats are typically formed from an oxidation-resistant alloy such as MCrAlY where M is iron, cobalt and/or nickel, or from a diffusion aluminide or platinum aluminide that forms an oxidation-resistant intermetallic.

While thermal barrier coating systems provide significant thermal protection to the underlying component substrate, internal cooling of components such as combustor liners is generally necessary, and may be employed in combination with or in lieu of a thermal barrier coating. Combustor liners of a gas turbine engine often require a complex cooling scheme in which cooling air flows around the combustor and is then discharged into the combustor through carefully configured cooling holes in the combustor liner. The performance of a combustor is directly related to the ability to provide uniform cooling of its surfaces with a limited amount of cooling air. Consequently, processes by which cooling holes and their openings are formed and configured are often critical because the size and shape of each opening determine the amount of air flow exiting the opening and the distribution of the air flow across the surface, and affect the overall flow distribution within the combustor. Other factors, such as local surface temperature of the liner, are also affected by variations in opening size.

For combustor liners without a thermal barrier coating, cooling holes are typically formed by such conventional drilling techniques as electrical-discharge machining (EDM) and laser machining. However, EDM cannot be used to form cooling holes in a combustor liner having a ceramic TBC since the ceramic is electrically nonconducting, and laser machining is prone to spalling the brittle ceramic TBC by cracking the interface between the substrate and the ceramic. Accordingly, cooling holes have been required to be formed by EDM and/or laser machining prior to applying the TBC system, limiting the thickness of the TBC which can be applied or necessitating a final operation to remove ceramic from the cooling holes in order to reestablish the desired size and shape of the openings. Conventional processes involve protecting cooling holes from TBC deposition or complete removal of applied TBC from the holes to obtain the desired hole geometry. This leaves the underlying metal surface exposed to hostile environmental conditions at the hole locations.

Current repair methods for air-cooled components such as combustor liners include welding thermal fatigue cracks. The location of openings in the panels, such as cooling or dilution holes, and the use of thermal barrier coatings add additional complexity to the use of welds and patches. In many instances, protective coatings must be removed from an entire panel and/or an entire liner to gain access to the underlying metal itself, then reapplying protective coatings. However, conventional reapplication processes involve protecting cooling holes from TBC deposition or complete removal of applied TBC from the holes to obtain the desired hole geometry. This leaves the underlying metal surface exposed to hostile environmental conditions at the hole locations. In some cases, repair of such panels is not a feasible option, and instead the entire combustor liner is replaced.

Because conventional designs may rely upon the underlying metal substrate to define the finished hole geometry in the absence of a TBC system applied to the hole surfaces, damage to or repair procedures performed on the holes in the metal substrate may affect the performance of the repaired part. Accordingly, a method is desired for manufacturing air-cooled components such as combustor liners in a manner which is economically and physically feasible, provides enhanced protection to the substrate in the vicinity of the cooling holes, and which yields a satisfactory cooling hole geometry both as-manufactured and as-repaired.

### BRIEF SUMMARY OF THE INVENTION

In one aspect, described herein is a component suitable for use in a gas turbine engine. The component includes a substrate defining a surface of the component and has a first surface and a second surface. At least one aperture extends through the substrate from the first surface to the second surface, and has a first open area. The component has a first coating on at least one of the first surface and the second surface adjacent to the at least one aperture. The component also has a second coating overlying the first coating adjacent to the at least one aperture, such that at least a portion of the first coating is exposed adjacent to the at least one aperture. The first coating defines a second open area which is smaller than the first open area.

In another aspect, described herein is a method of manufacturing a component suitable for use in a gas turbine engine, comprising the steps of forming the component from a substrate having a first surface and a second surface, forming at least one aperture through the substrate from the first surface to the second surface having a first open area, applying a first coating to at least one of the first surface and the second surface adjacent to the at least one aperture, the aperture remaining at least partially unobstructed by the first coating, applying a second coating to the first coating adjacent to the at least one aperture, the aperture remaining at least partially unobstructed by the second coating, and removing the second coating from the aperture, leaving most or all of the first coating to define a second open area which is smaller than the first open area.

In a further aspect, described herein is a method of repairing a component suitable for use in a gas turbine engine, the component having a substrate with first and second surfaces and at least one aperture extending through the substrate from the first surface to the second surface, the aperture having a first open area, the method comprising the steps of removing coatings from the component, repairing any defects in the substrate of the component, applying a first coating to at least one of the first surface and the second surface adjacent to the at least one aperture, the aperture remaining at least partially unobstructed by the first coating, applying a second coating to the first coating adjacent to the at least one aperture, the aperture remaining at least partially unobstructed by the second coating, and removing the second coating from the aperture, leaving most or all of the first coating to define a second open area which is smaller than the first open area.

### BRIEF DESCRIPTION OF THE DRAWINGS

The accompanying drawings illustrate several embodiments of the technology described herein, wherein:

FIG. 1 is a schematic illustration of an exemplary gas turbine engine;

FIG. 2 is a schematic cross-sectional view of an exemplary combustor assembly that may be used with the gas turbine engine shown in FIG. 1;

FIG. 3 is an enlarged perspective view of a portion of an exemplary combustor liner that may be used with the combustor assembly shown in FIG. 2;

FIG. 4 is an enlarged partial cross-sectional view of the combustor liner shown in FIG. 3 before a coating application; and

FIG. 5 is an enlarged partial cross-sectional view of the combustor liner shown in FIG. 4 after a coating application; and

FIG. 6 is an enlarged partial cross-sectional view of the combustor liner shown in FIG. 5 after removing some coating material; and

FIG. 7 is a flowchart illustrating steps associated with an exemplary manufacturing method; and

FIG. 8 is a flowchart illustrating steps associated with an exemplary repair method.

### DETAILED DESCRIPTION OF THE INVENTION

The present invention is generally applicable to air-cooled components, and particularly those that are protected from a thermally and chemically hostile environment by a thermal barrier coating system. Notable examples of such components include the high and low pressure turbine nozzles and blades, shrouds, combustor liners and augmentor hardware of gas turbine engines. The advantages of this invention are particularly applicable to gas turbine engine components that employ internal cooling and a thermal barrier coating to maintain the service temperature of the component at an acceptable level while operating in a thermally hostile environment.

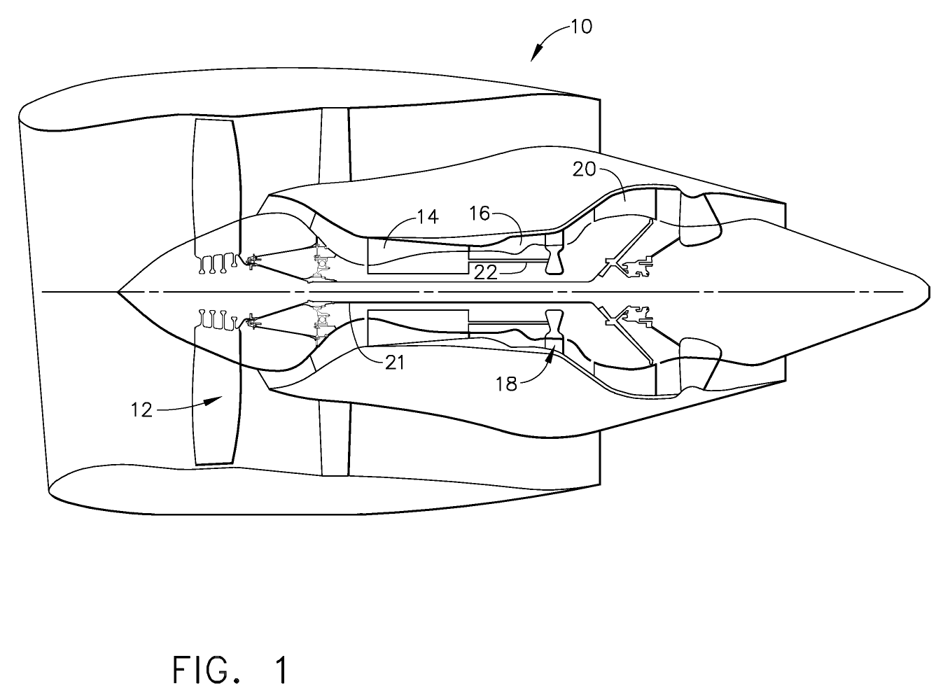

FIG. 1 is a schematic illustration of an exemplary gas turbine engine 10. Engine 10 includes a low pressure compressor 12, a high pressure compressor 14, and a combustor assembly 16. Engine 10 also includes a high pressure turbine 18, and a low pressure turbine 20 arranged in a serial, axial flow relationship. Compressor 12 and turbine 20 are coupled by a first shaft 21, and compressor 14 and turbine 18 are coupled by a second shaft 22. In the exemplary embodiment, gas turbine engine 10 is a CFM-56 engine commercially available from CFM International, Inc., Cincinnati, Ohio. In another embodiment, gas turbine engine 10 is a CF-34 engine commercially available from GE's Aviation business, Cincinnati, Ohio.

In operation, air flows through low pressure compressor 12 and compressed air is supplied from low pressure compressor 12 to high pressure compressor 14. The highly compressed air is delivered to combustor 16. Airflow from combustor 16 drives turbines 18 and 20 and exits gas turbine engine 10 through a nozzle (not numbered).

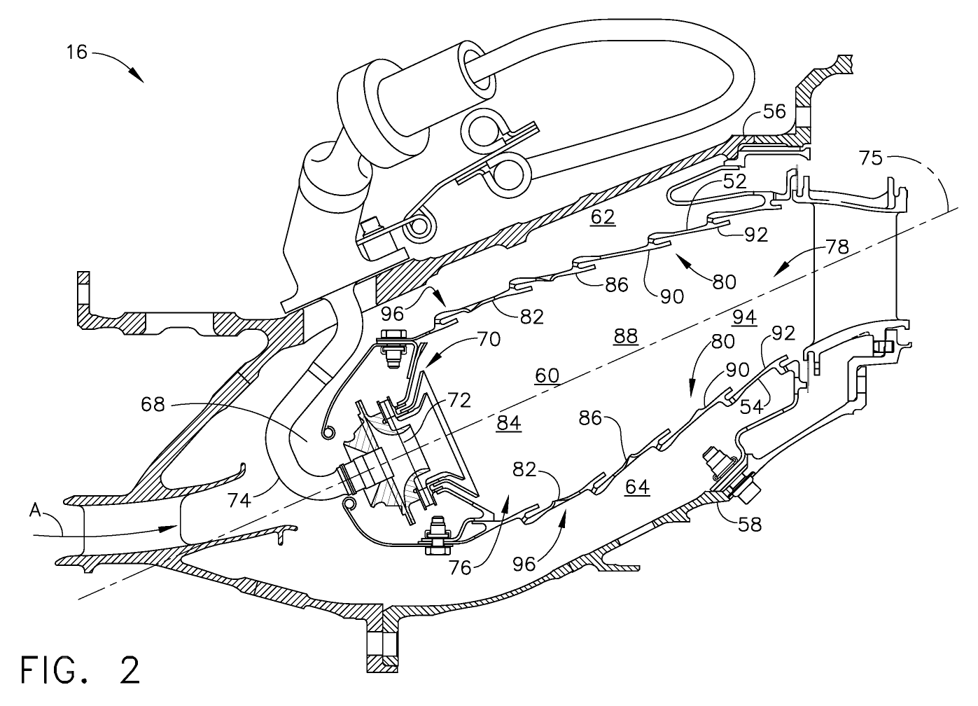

FIG. 2 is a schematic cross-sectional view of an exemplary combustor 16 that may be used with gas turbine engine 10 (shown in FIG. 1). Combustor 16 includes an outer liner 52 and an inner liner 54 disposed between an outer combustor casing 56 and an inner combustor casing 58. Outer and inner liners 52 and 54 are spaced radially from each other such that a combustion chamber 60 is defined therebetween. Outer liner 52 and outer casing 56 form an outer passage 62 therebetween, and inner liner 54 and inner casing 58 form an inner passage 64 therebetween. A cowl assembly 66 is coupled to the upstream ends of outer and inner liners 52 and 54, respectively. An annular opening 68 formed in cowl assembly 66 enables compressed air entering combustor 16 through a diffuse opening in a direction generally indicated by arrow A. The compressed air flows through annular opening 68 to support combustion and to facilitate cooling liners 52 and 54.

An annular dome plate 70 extends between, and is coupled to, outer and inner liners 52 and 54 near their upstream ends. A plurality of circumferentially spaced swirler assemblies 72 are coupled to dome plate 70. Each swirler assembly 72 receives compressed air from opening 68 and fuel from a corresponding fuel injector 74. Fuel and air are swirled and mixed together by swirler assemblies 72, and the resulting fuel/air mixture is discharged into combustion chamber 60. Combustor 16 includes a longitudinal axis 75 which extends from a forward end 76 to an aft end 78 of combustor 16. In the exemplary embodiment, combustor 16 is a single annular combustor. Alternatively, combustor 16 may be any other combustor, including, but not limited to a double annular combustor.

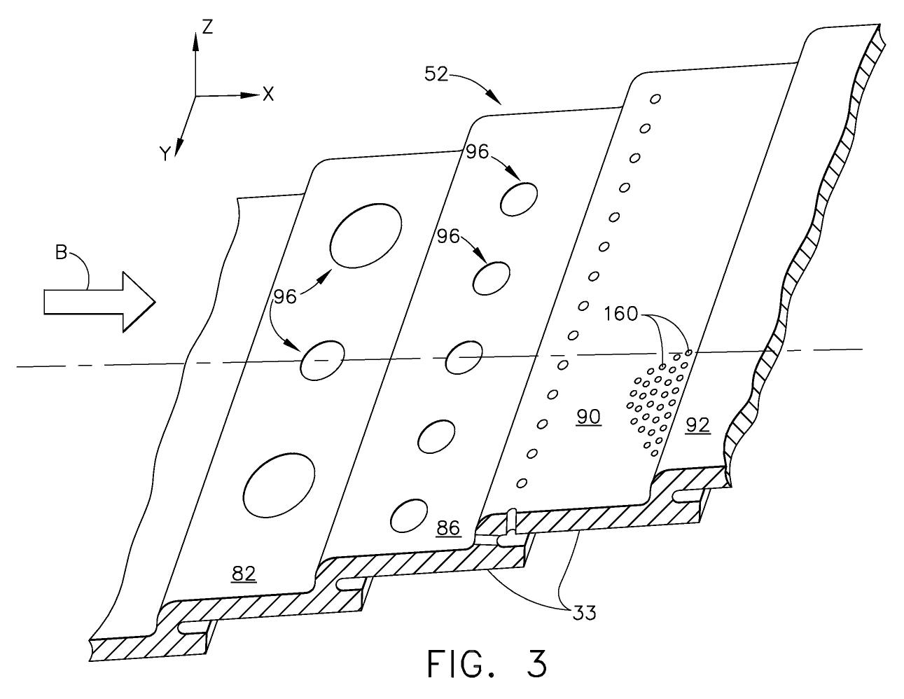

In the exemplary embodiment, outer and inner liners 52 and 54 each include a plurality of overlapped panels 80. More specifically, in the exemplary embodiment, outer liner 52 includes five panels 80 and inner liner 54 includes four panels 80. In an alternative embodiment, both outer and inner liner 52 and 54 may each include any number of panels 80. Panels 80 define combustion chamber 60 within combustor 16. Specifically, in the exemplary embodiment, a pair of first panels 82, positioned upstream, define a primary combustion zone 84, a pair of second panels 86, positioned downstream from first panels 82, define an intermediate combustion zone 88, and a pair of third panels 90, positioned downstream (direction B in FIG. 3) from second panels 86, and a pair of fourth panels 92, positioned downstream from third panels 90, define a downstream dilution combustion zone 94.

Combustor liners may include dilution holes to provide air into the combustion environment with the combustor, such as to alter the temperature distribution or combustion characteristics. Dilution air is introduced primarily into combustor chamber 60 through a plurality of circumferentially spaced dilution holes 96 that extend through either or both of outer and inner liners 52 and 54. In the exemplary embodiment, dilution holes 96 are each substantially circular. Dilution holes may be adapted (sized, shaped, and/or arranged) as needed to accomplish the durability and performance objectives of the particular component and the particular product application.

FIG. 3 illustrates an exemplary combustor liner 52 that may be used with combustor 16. Liner 52 also includes a plurality of cooling holes 160 formed in the third panel 90 that facilitate cooling liner 52. Although, only one group of cooling holes 160 is illustrated in the third panel 90, it should be understood that the group of cooling holes 160 are spaced circumferentially about the third panel 90. It should be appreciated that each group of cooling holes 160 is positioned corresponding hot spots to facilitate channeling cooling fluid onto the corresponding hot spot. Third panel 90 includes any number of cooling holes 160 that facilitates cooling of liner 52.

During operation of gas turbine engine 10, an inner surface 33 of liner 52 becomes hot and requires cooling. Consequently, in the exemplary embodiment, cooling features such as cooling holes 160 are positioned in liner 52 to facilitate channeling cooling fluid onto hot spots of liner 52. More specifically, cooling holes 160 channel cooling fluid from outer passage 62 and/or inner passage 64 to the combustion chamber 60, thus providing a layer of cooling fluid to inner surface 33. It should be appreciated that other embodiments may use any configuration of cooling holes 160 that enables cooling holes 160 to function as described herein. Similarly, holes 160 could be in liner 54 to cool its outer surface.

During operation, as atomized fuel is injecting into combustion chamber 60 and ignited, heat is generated within combustion chamber 60. Although air enters combustion chamber 60 through cooling features 160 and forms a thin protective boundary of air along combustor liner surface 33, a variation in exposure of combustor liner surfaces to high temperatures may induce thermal stresses into panels 80. As a result of continued exposure to thermal stresses, over time, panels 80 may become deteriorated.

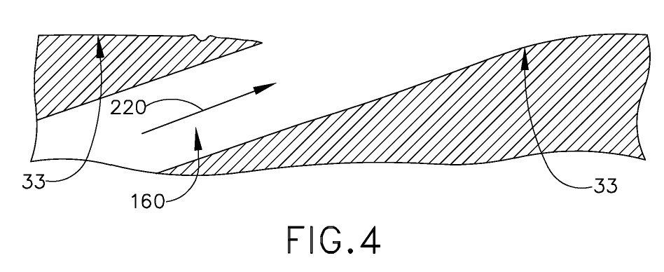

FIG. 4 is an enlarged partial cross-sectional view of a portion of the combustor liner 52 to illustrate the relationship between the cooling hole 160 and the liner surface 33, as well as the axis 220 of the hole 160.

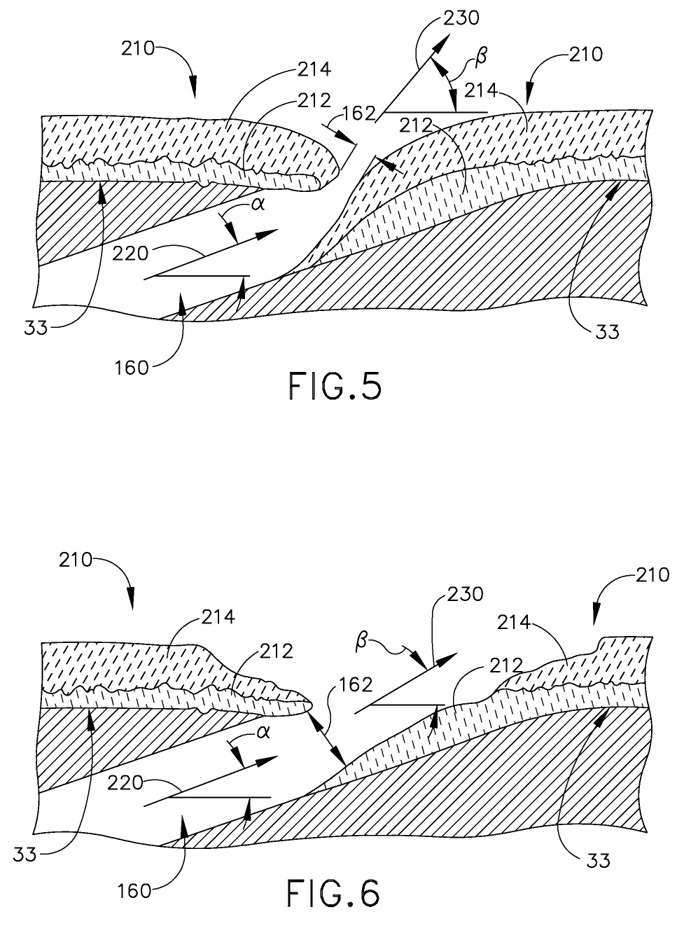

Referring now to FIGS. 5 and 6, a layer 210 of thermal barrier material is applied to the combustor liner 52 shown in FIG. 4 on combustor liner surface 33. Thermal barrier material further insulates combustor liner surface 33 from high temperature combustion gases. Layer 210 includes an inner layer 212, such as a bond coat layer, and an outer layer 214, such as a thermal barrier layer.

The exemplary methods will be described in terms of an air-cooled component, such as a combustor liner 52, whose metallic substrate 33 is protected by a thermal barrier coating system composed of a bond coat 212 formed on the substrate (inner surface 33), and a ceramic layer 214 adhered to the surface 33 with the bond coat 212. Bond coat 212 and ceramic layer 214 may each be a single layer of material, or formed of two or more layers (i.e., multi-layer) of appropriate materials. As is the situation with high temperature components of a gas turbine engine, the surface 33 may be an iron, nickel or cobalt-base superalloy. The bond coat 212 is preferably an oxidation-resistant composition, such as a diffusion aluminide or MCrAlY, that forms an alumina (Al₂O₃) layer or scale (not shown) on its surface during exposure to elevated temperatures. The alumina scale protects the underlying superalloy surface 33 from oxidation and provides a surface to which the ceramic layer 214 more tenaciously adheres.

The ceramic layer 214 can be deposited by air plasma spraying (APS), low pressure plasma spraying (LPPS), or physical vapor deposition (PVD) techniques such as electron beam physical vapor deposition (EBPVD), the latter of which yields a strain-tolerant columnar grain structure. An exemplary material for the ceramic layer 214 is zirconia partially stabilized with yttria (yttria-stabilized zirconia, or YSZ), though zirconia fully stabilized with yttria could be used, as well as zirconia stabilized by other oxides, such as magnesia (MgO), calcia (CaO), ceria (CeO₂) or scandia (Sc₂O₃).

The method of this invention entails producing a cooling hole 160 (shown in FIGS. 4-6) which can project through the ceramic layer 214, bond coat 212 and surface 33 via an opening 162, to achieve a configuration for the cooling hole 160 and opening 162 that provides an appropriately metered distribution of cooling air across the external surface of the component, such as liner 52. As shown in FIG. 5, the cooling hole opening 162 as initially coated forms a small opening (having axis 230) aimed at a steep angle (angle β) to the surface. As shown in FIG. 6, after removing the portion of the ceramic layer 214 that is in alignment with the hole, the opening 162 is at a relatively shallow angle to the surface 33 such that the cooling air flowing through the opening 162 can be laid down as an effective film over the component surface during operation.

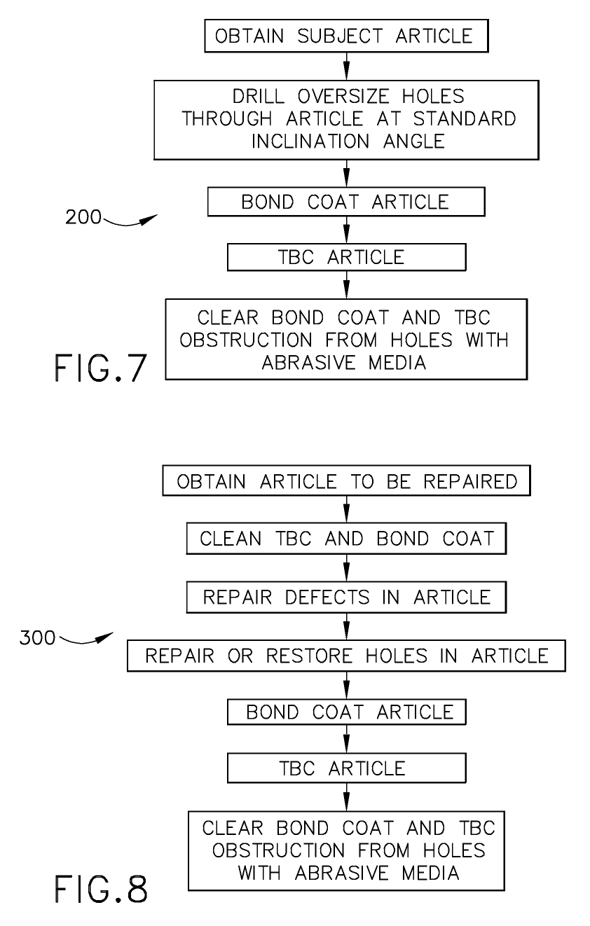

FIGS. 7 and 8 illustrate in flow diagram form the exemplary methods described in greater detail herein. While both methods share some common steps, the method 200 is particularly suited for manufacturing of new air-cooled components while the method 300 is particularly suited for repair and restoration of air-cooled components during their service life.

As shown in FIG. 4, a first step of this exemplary method is to form a hole 160 through the liner 52. A second step is then to apply as shown in FIG. 5 the bond coat 212 and ceramic layer 214 to the surface 33. Due to coating buildup at the edges of the hole 160, the resulting hole opening 162 is smaller in cross-sectional diameter than the cooling hole 160 required for the liner 52, but is not completely obstructed such that the location of the hole and at least a portion of its cross-section remain substantially free of obstruction. For example, for a cooling hole 160 having a diameter of about 0.035 inch (about 0.9 mm) to about 0.040 inch (about 1.0 mm), the opening 162 after coating preferably has a diameter of about 0.020 inch (about 0.5 mm), or roughly half that intended for the cooling hole 160, such that a “witness hole” remains visible and accessible through the coatings. Suitable techniques for forming the hole 160 include EDM, though it is foreseeable that the hole 160 could be formed by such other methods as casting, laser, or drilling with an abrasive water jet. As a result of the drilling operation, the hole 160 has a substantially uniform circular cross-section, and forms a non-normal angle (angle α) to the surface 33.

Once the hole 160 is formed, and the bond coat 212 and ceramic layer 214 are applied, the component (liner 52) is processed through a carefully controlled operation that uses a pressurized fluid stream targeted at the hole 160, such as from the uncoated side of the liner 52, to produce the cooling hole 160 and opening 162 shown in FIG. 5. Various fluids could be used, such as air or water, containing a media such as glass beads or an abrasive grit to provide an abrasive action on coating materials overlying the hole 160.

An operation as described herein has been found to provide sufficient energy to enlarge the opening 162 to the size desired as well as the angle desired by removing the ceramic TBC layer but not the bond coat layer or underlying parent material such as the metal substrate. Therefore, while the operation removes the ceramic layer 214 most or all of the underlying bond coat 212 remains on the surface of the opening adjacent to the cooling hole 160, such that the bond coat layer provides protection for the edges of the liner in the vicinity of the cooling hole both during manufacture and in service. Because the operation uses mechanical energy rather than heat energy, it does not damage or spall the bond coat 212 or ceramic layer 214 surrounding the hole 160 and forming the edges of the resulting hole opening 162.

The method is capable of appropriately sizing and shaping cooling holes and openings through a ceramic thermal barrier coating (TBC) and its underlying substrate. The abrasive fluid stream also serves to finish the hole and its opening, including the desired size and shape of the hole and opening, without removing or damaging the ceramic surrounding the cooling hole and opening.

If a field returned engine, such as engine 10, indicates that combustor liner 52 includes at least one deteriorated panel 80, a variety of repair methods may be employed to restore combustor liner 52 to serviceable condition. These repair methods may include replacement of the entire liner, a complete panel, and/or a portion or segment of a liner panel, as well as repair of cracks such as by welding them closed.

During a repair operation, all dirt, foreign material, and coatings are normally removed from a component such as a combustor liner to permit a detailed inspection of the component. Any defects in the substrate, such as cracks, are then repaired using suitable and approved methods such as welding, brazing, or replacement of discrete sections of the component. Holes such as cooling holes may be redrilled and/or repaired as needed to restore them to the appropriate size, shape, and pattern.

Once the surfaces of the component have been suitably repaired, protective thermal barrier coatings may be applied to component surfaces utilizing the exemplary methods described above. Because the finished opening dimensions are carefully controlled and are defined by a removable and replaceable coating system as described herein, it is possible to perform and repeat the repair process while maintaining finished cooling hole dimensions within specifications.

Because components such as deteriorated liners are repaired using the method described herein, utilizing readily available coating techniques, combustors may be returned to service using a repair process that facilitates improved savings in comparison to removing and replacing entire combustor liners or large patches or complete panels.

Although the apparatus and methods described herein are described in the context of cooling holes in a combustor liner of a gas turbine engine, it is understood that the apparatus and methods are not limited to gas turbine engines, combustor liners, or cooling holes. Likewise, the gas turbine engine and combustor liner components illustrated are not limited to the specific embodiments described herein, but rather, components of both the gas turbine engine and the combustor liner can be utilized independently and separately from other components described herein.

While the invention has been described in terms of various specific embodiments, those skilled in the art will recognize that the invention can be practiced with modification within the spirit and scope of the claims.

What is claimed is:

1. A component suitable for use in a gas turbine engine, said component comprising:
a substrate defining a surface of said component, said substrate having a first surface and a second surface;
at least one aperture extending through said substrate from said first surface to said second surface, said aperture having a first open area;
a first coating on at least one of said first surface and said second surface adjacent to said at least one aperture; and
a second coating overlying said first coating adjacent to said at least one aperture, such that at least a portion of said first coating is exposed adjacent to said at least one aperture;
wherein said first coating defines a second open area which is smaller than said first open area.

2. The component of claim 1, wherein said first coating covers an edge formed where said at least one aperture meets said at least one of said first surface and said second surface.

3. The component of claim 1, wherein said aperture defines an axis which forms a first angle other than 90 degrees to a surface of said substrate coated by said first coating.

4. The component of claim 3, wherein said second open area forms a second angle to a surface of said substrate which is different than said first angle.

5. The component of claim 1, wherein said component includes a plurality of apertures.

6. The component of claim 1, wherein said first coating and said second coating form a thermal barrier system.

7. The component of claim 6, wherein said first coating is a bond coat material.

8. The component of claim 6, wherein said second coating is a ceramic layer material.

9. The component of claim 1, wherein said substrate is a metallic material.

10. The component of claim 1, wherein said component is a combustor liner.

11. A method of manufacturing a component suitable for use in a gas turbine engine, said method comprising the steps of:
forming said component from a substrate having a first surface and a second surface;
forming at least one aperture through said substrate from said first surface to said second surface, said aperture having a first open area;
applying a first coating to at least one of said first surface and said second surface adjacent to said at least one aperture, said aperture remaining at least partially unobstructed by said first coating;
applying a second coating to said first coating adjacent to said at least one aperture, said aperture remaining at least partially unobstructed by said second coating; and
removing said second coating from said aperture, leaving most or all of said first coating to define a second open area which is smaller than said first open area.

12. The method of claim 11, wherein at least one of said first coating and said second coating are applied at an angle to said at least one of said first surface and said second surface.

13. The method of claim 11, wherein at least one of said removal steps is accomplished by a stream of abrasive media.

14. The method of claim 13, wherein said stream of abrasive media comprises glass beads suspended in a stream of air.

15. The method of claim 13, wherein said stream of abrasive media is directed through said at least one aperture from a non-coated side of said substrate.

16. A method of repairing a component suitable for use in a gas turbine engine, said component having a substrate with first and second surfaces and at least one aperture extending through said substrate from said first surface to said second surface, said aperture having a first open area, said method comprising the steps of:
removing coatings from said component;
repairing any defects in said substrate of said component;
applying a first coating to at least one of said first surface and said second surface adjacent to said at least one aperture, said aperture remaining at least partially unobstructed by said first coating;
applying a second coating to said first coating adjacent to said at least one aperture, said aperture remaining at least partially unobstructed by said second coating; and
removing said second coating from said aperture leaving most or all of said first coating to define a second open area which is smaller than said first open area.

17. The method of claim 16, wherein at least one of said first coating and said second coating are applied at an angle to said at least one of said first surface and said second surface.

18. The method of claim 16, wherein at least one of said removal steps is accomplished by a stream of abrasive media.

19. The method of claim 18, wherein said stream of abrasive media comprises glass beads suspended in a stream of air.

20. The method of claim 18, wherein said stream of abrasive media is directed through said at least one aperture from a non-coated side of said substrate.
